(19) United States
(12) Patent Application Publication
(10) Pub. No.: US 2006/0226892 A1
(43) Pub. Date: Oct. 12, 2006

(54) Circuit for generating a reference current

(75) Inventors: Jean-Luc Moro, Grenoble (FR); Serge Ramet, Grenoble (FR); Marc Sabut, Eybens (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 11/401,548

(22) Filed: Apr. 11, 2006

(30) Foreign Application Priority Data
Apr. 12, 2005 (FR) 05/50932

(51) Int. Cl. G05F 1/10

(52) U.S. Cl. 327/538

(57) ABSTRACT

A circuit for generating a reference current, including, between two terminals of application of a supply voltage: at least a first branch formed of at least a first and of at least a second transistors in series; at least a second branch formed of at least a third and of at least a fourth transistors in series with a switched-capacitance circuit.

### BACKGROUND OF THE INVENTION

1. Field of the Invention

The present invention generally relates to electronic circuits and, more specifically, to the generation of reference currents for biasing means, intended for amplifiers.

The present invention applies, for example, to analog-to-digital converters and to the generation of currents for biasing the differential stages of the operational amplifiers of the converter. The present invention also applies to active filters. More generally, the present invention applies to any reference current generator.

2. Discussion of the Related Art

FIG. 1 schematically shows in the form of blocks an analog-to-digital converter 1 (ADC) of the type to which the present invention applies. Such a converter is supplied by a D.C. voltage Vdd applied between two terminals 2 and 3 of circuit 1. In the example of FIG. 1, converter 1 has differential inputs. A differential signal Vin is applied between two input terminals 4 and 5 of the converter. A sampling frequency fc is set by a clock signal applied to a clock input 6. Circuit 1 provides a binary signal OUT over n bits to a series output or several parallel outputs 7. The converter also integrates or receives two voltage reference signals, not shown, and integrates or is connected to at least one circuit 30 (CREF) for generating a reference current intended to bias operational amplifiers (not shown in FIG. 1) of converter 1.

FIG. 2 shows an example of a simplified diagram of an operational amplifier 10 of the type to which the present invention applies. This amplifier comprises, between terminals 2 and 3 of application of a D.C. supply voltage Vdd, a differential stage formed of two parallel branches of transistors (here, MOS transistors), in series with a current source 20 setting a bias current Ip. Each branch comprises, for example, a P-channel MOS transistor MP11, MP12 in series with an N-channel MOS transistor MN11, MN12. The gates of transistors MP11 and MP12 are connected together to the drain of transistor MP11 to form an active load, while the gates of transistors MN11 and MN12 define differential inputs, respectively non-inverting 14 (+) and inverting 15 (−), of amplifier 1. The drain of transistor MN12, connected to the drain of transistor MP12, defines an output terminal 17 of the amplifier. The common sources of transistors MN11 and MN12 are connected to a first terminal 22 of current source 20 having its other terminal 23 connected to ground 3. The source of current 20 is formed of a transistor MN20, for example, an N-channel MOS transistor, assembled as a current mirror on a transistor (not shown in FIG. 2) for copying a reference current compensated at least in temperature.

FIG. 3 shows a conventional example of a generator 30 of a reference current intended to be copied to provide one or several bias currents for amplifiers of the type shown in FIG. 2. Such a generator is based on the resistive conversion of a voltage provided by transistors, compensated in temperature and in transistor manufacturing tolerances.

In the example of FIG. 3, a MOS-technology generator, formed of two parallel branches between two terminals 2 and 3 of application of a D.C. supply voltage Vdd, is assumed. A first branch comprises two MOS transistors, respectively with a P channel MP31 and an N channel MN31, in series between terminals 2 and 3. A second branch comprises two MOS transistors, respectively with a P channel MP32 and an N channel MN32, in series with a resistor R30 between lines 2 and 3. The gates of transistors MP31 and MP32 are connected together to the drain of transistor MP32 (drain of transistor MN32). The gates of transistors MN31 and MN32 are connected together to the drain of transistor MN31 (drain of transistor MP31).

Current 10 flowing in each of the branches is equal to the ratio of the difference (ΔVgs) of the gate-source voltages (Vgs31 and Vgs32) of transistors MN31 and MN32 to the value of resistor R30 (I0=ΔVgs/R30).

To bias amplifiers of the type of that in FIG. 2, current I0 is then duplicated by current mirror assemblies.

For example, a transistor MP21 is in series with a transistor MN21 between terminals 2 and 3. Transistor MP21 is mirror-assembled on transistor MP32 (its gate is connected to he drain of transistor MP32) and transistor MN21 is diode-assembled (its gate is connected to its drain). The gate of transistor MN20 of the amplifier to be biased is connected to the drains of transistors MP21 and MN21.

Ratio k between the respective surface areas of transistors MN31 and MN32 sets the significance of difference ΔVgs, and thus the amplitude of current I0 for a given resistance R. This current is selected so that the bias circuit is able to provide a sufficient current to all the amplifiers that it biases. A surface area ratio k between transistors greater than one (generally ranging between 5 and 10) is generally selected. In FIG. 3, surface area ratio k has been illustrated, assuming a transistor MN31 of unity size (width W to length L of the gate of transistor MN31 equal to 1) and a transistor MN32 of size k (width W to length L of the gate of transistor MN32 equal to k). A unity surface area ratio can be found at the level of current-mirror assembled transistors MP31 and MP32.

A disadvantage of the circuit of FIG. 3 is that the integration of resistor R30, most often in the form of a polysilicon resistor, makes it necessary to take into account its manufacturing tolerances in the transistor sizing to take the worst case into account. Indeed, such tolerances (on the order of 20%) are not compensated for by the assembly.

Another disadvantage of the circuit of FIG. 3 is that the worst case must also be taken into account for the operating frequencies of the amplifiers (10, FIG. 2) biased by the assembly. Indeed, the higher the maximum frequency of the amplifier passband, the more current said amplifier consumes, and thus the greater its bias current Ip must be. In the example of application to analog-to-digital converters, this leads to taking into account the maximum sampling frequency of the converter. For example, an analog-to-digital converter provided to operate with a sampling frequency ranging up to 100 MHz will require a current generator sized accordingly, even though in its application assembly, this converter risks only working with a 10-MHz sampling frequency. In the example of application to an active filter, this results in taking into account the maximum operating frequency of the filter.

Further, the worst-case constraints for the resistance and the maximum frequency are contrary. Indeed, providing the worst resistance (maximum value) decreases, for a given sizing of the transistors, current I0. Currently, providing a high frequency requires increasing the available current I0.

Further, referring to the assembly of FIG. 2, the passband of amplifier 1 is a function of the ratio of transconductance gm10 of this amplifier to the capacitive value of its output impedance. Indeed, an operational amplifier 10 always has, in its application assembly, its output connected to ground 3 (or more generally to a line of application of the supply voltage) by a capacitor (C1 in dotted lines in FIG. 2). Now, capacitor C1 also has manufacturing tolerances. This thus also leads to sizing the circuit for generating current I0 according to the maximum possible values of these equivalent output capacitances. Further, the variation goes in the same direction as that linked to resistance R30, so that these worst cases add.

Such sizings taking into account the worst cases result in high losses in most applications, the excess bias current of the amplifiers being dissipated in the transistors of their respective branches.

Document US-A-2002/0180512 discloses a system for tuning a VLSI circuit in which an array of switched capacitors is connected to a branch of a current mirror another branch of which is in series with an external resistor. The switched capacitor array is for providing a fixed current for an also fixed reference voltage provided to the generator.

Document U.S. Pat. No. 5,969,513 discloses the use of switched capacitors current sources in voltage regulators using a fixed reference voltage and in which each capacitor is in series with a single transistor.

Document U.S. Pat. No. 5,408,174 discloses the generation of a reference current by means of a switched capacitor in which the commutation rate determines the value of the current and which uses resistive elements to set a voltage reference.

### SUMMARY OF THE INVENTION

The present invention aims at overcoming all or part of the disadvantages of known reference current generation circuits.

The present invention more specifically aims at reference current generation circuits having the object of being reproduced to bias one or several amplifiers.

The present invention also aims at providing a circuit having a current consumption which adapts to the current needs of the amplifiers that it biases.

The present invention also aims at avoiding the overconsumption due to the manufacturing tolerances of the resistor of a reference current generation circuit.

The present invention also aims at providing a circuit which is particularly well adapted to applications in which a clock frequency is available.

To achieve all or part of these objects, the present invention provides a circuit for generating a reference current, comprising, between two terminals of application of a supply voltage:

at least a first branch of at least a first and of at least a second transistors in series;

at least a second branch of at least a third and of at least a fourth transistors in series with a switched-capacitance circuit comprising at least a first capacitive element.

According to an embodiment of the present invention, a second capacitive element is provided across the switched-capacitance circuit.

According to an embodiment of the present invention, said second capacitive element is of a capacity greater within a ratio of at least five, preferably of at least ten, than the capacitance of the first capacitive element forming the switched-capacitance circuit.

According to an embodiment of the present invention, said switched-capacitance circuit comprises said first capacitive element in parallel with a first switch, all in series with a second capacitor.

According to an embodiment of the present invention, said first capacitive element is formed in a same technology as a capacitive element of a load of an amplifier biased from a copying of the reference current.

According to an embodiment of the present invention, an element controls the switched-capacitance circuit at a frequency which is a function of the magnitude of the required reference current.

According to an embodiment of the present invention, said frequency corresponds to the working frequency of at least one amplifier, a bias current of which is obtained by copying of the reference current.

According to an embodiment of the present invention, the control terminals of the first and third transistors are connected to the interconnection between the third and fourth transistors, the control terminals of the second and fourth transistors being connected to the interconnection between the first and second transistors.

According to an embodiment of the present invention, the control terminals of the first and third transistors are connected to the interconnection between the first and second transistors, the control terminals of the second and fourth transistors being connected to the interconnection of a fifth and of a sixth transistor in series forming a third branch between said supply terminals, the control terminal of the fifth transistor being connected to the interconnection between the third and fourth transistors and the sixth transistor being diode-assembled.

According to an embodiment of the present invention, the first and third transistors are MOS transistors of a first channel type, the second and fourth transistors being MOS transistors of a second channel type.

The present invention also provides an amplifier comprising a bias current source, the bias current being obtained by copying of a reference current generated by a circuit for generating such a current.

The present invention also provides an analog-to-digital converter comprising at least such an amplifier.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, very schematically shows in the form of blocks an analog-to-digital converter with differential inputs of the type to which the present invention more specifically applies;

FIG. 2, previously described, very schematically shows an example of an operation amplifier of the type to which the present invention applies;

FIG. 3, previously described, shows a conventional example of a circuit for generating a reference current compensated in temperature and in MOS transistor manufacturing tolerances;

FIG. 4 shows a first embodiment of a reference current generation circuit according to the present invention; and

FIG. 5 shows a second embodiment of a reference current generation circuit according to the present invention.

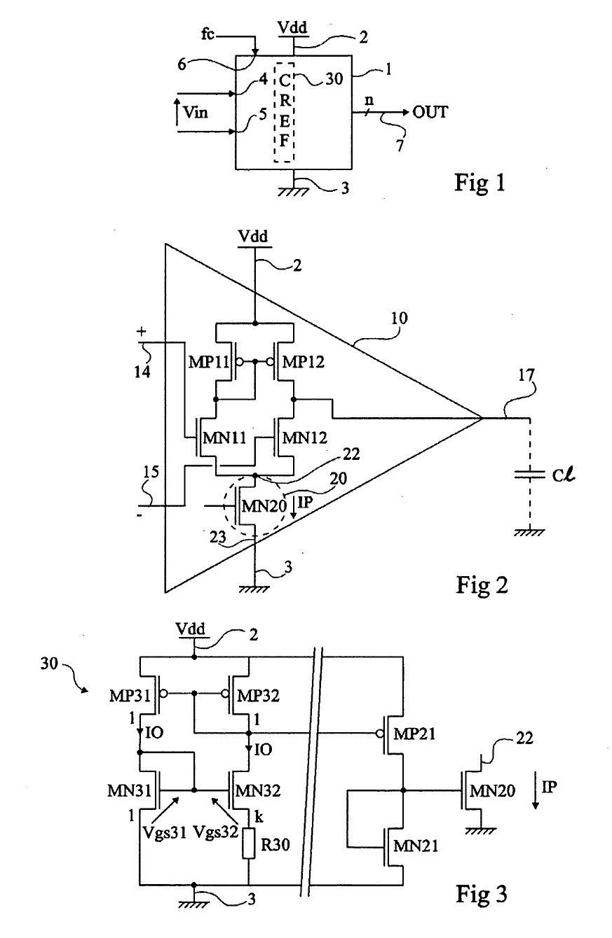

### DETAILED DESCRIPTION

The same elements have been designated with the same reference numerals in the different drawings. For clarity, only those steps and elements which are necessary to the understanding of the present invention have been shown in the drawings and will be described hereafter. In particular, the circuits biased by replication (with or without a multiplication factor) of a current generated by the circuit of the present invention (for example, the operational amplifiers of an analog-to-digital circuit) have not been detailed, the present invention requiring no modification of the circuits connected downstream of the reference current generation circuit.

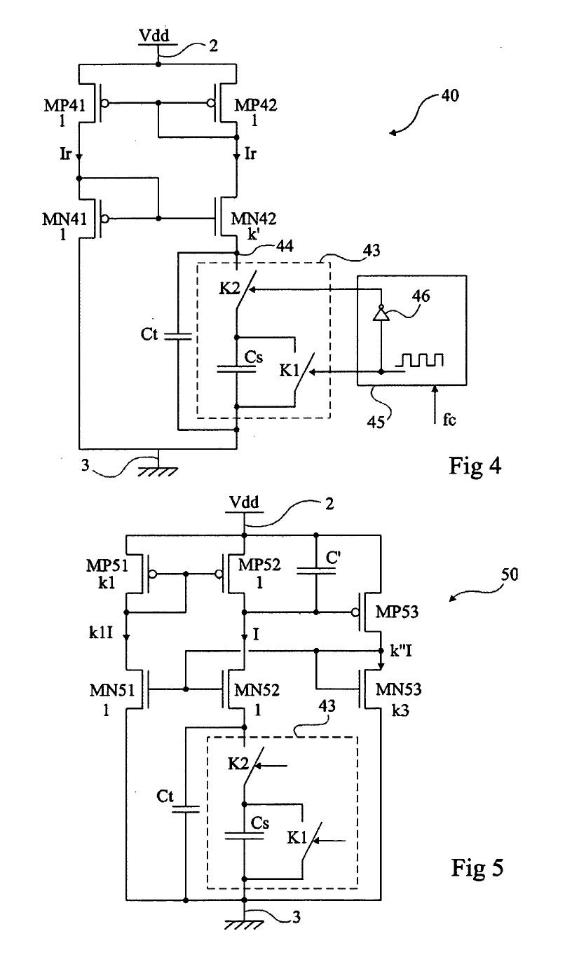

FIG. 4 shows a reference current generation circuit 40 according to a first embodiment of the present invention.

Circuit 40 generates a current Ir intended to be copied by current mirror assemblies to bias, for example, differential stages of transconductance amplifiers of the type described in relation with FIG. 2. The present invention will be described in relation with such an example of amplifier but it should be noted that it more generally applies to the generation of a reference current and that the application for biasing any amplifier, operational or not, differential or not, etc. is a preferred application.

Circuit 40 comprises two parallel branches between two terminals 2 and 3 of application of a D.C. supply voltage Vdd. A first branch comprises two MOS transistors, respectively with a P channel MP41 and with an N channel MN41, in series between terminals 2 and 3. According to this embodiment of the present invention, a second branch comprises two MOS transistors, respectively with a P channel MP42 and with an N channel MN42, in series with a switched-capacitance circuit 43 between terminals 2 and 3. Circuit 43 replaces resistor R30 of the assembly of FIG. 3. The gates of transistors MP41 and MP42 are connected together to the drain of transistor MP42 (drain of transistor MN42). The gates of transistors MN41 and MN42 are connected together to the drain of transistor MN41 (drain of transistor MP41).

Circuit 43 is, for example, formed of a first capacitive element Cs (for example, a capacitor) in parallel with a first capacitor K1 and in series with a second switch K2 between source 44 of transistor MN42 and supply terminal 3 (the ground). Switches K1 and K2 are controlled by a reverse circuit 45 (inverter 46), alternately at a frequency fc received by circuit 45 and which depends on the amplitude of the required current Ir, and thus on bias currents Ip of the amplifiers connected to circuit 40. For each half-period of control frequency fc, switch K2 is turned on (switch K1 off) and capacitor Cs charges. For the other half-period, switch K1 is turned on (switch K2 off) and capacitor Cs discharges. In practice, circuit 45 shifts in time the turn-off and turn-on times to avoid simultaneous conduction of switches K1 and K2.

In the assembly of FIG. 4, a second capacitive element Ct (for example, a capacitor) directly connects source 44 of transistor MN42 to terminal 3. The function of capacitor Ct is to stabilize the voltage of terminal 44 so that circuit 43 may be assimilated to a resistive element of value R′=1/(Ct*fc). Accordingly, the capacitance of capacitor Ct is selected to be much greater (ratio of at least 5, preferably, at least 10) than that of capacitor Cs.

Circuit 40 then maintains the product of its transconductance gain gm40 by the equivalent resistance of circuit 43 substantially constant. Current Ir flowing in each of the branches is equal to the ratio of the difference (ΔVgs′) of the gate-source voltages (Vgs41 and Vgs42) of transistors MN41 and MN42 to the (current) value of the equivalent resistance R′ of circuit 45 (Ir=ΔVgs′*Ct*fc).

Ratio k′ between the respective surface areas of the transistors of the two branches sets the significance of difference ΔVgs′, and thus the amplitude of current Ir for a given resistance R′. As previously, this current is selected so that bias circuit 40 is able to provide a sufficient current to all the amplifiers that it biases. A ratio k′ between 5 and 10 is appropriate in most cases. In FIG. 4, surface ratio k′ has been illustrated assuming a transistor MN41 of unity size (width W to length L of the gate equal to 1) and a transistor MN42 of size k′ (width W to length L of the gate equal to k′). However, since resistance R′ can here be adapted to the operating frequency of the amplifiers (and thus to the bias current that they require), current Ir adapts to the current requirements of the biased amplifiers and thus generates no needless power consumption.

Considering the example of the amplifier of FIG. 2 where the maximum frequency of the passband is a function of ratio gm10/Cl, the present invention enables maintaining ratio gm10/(Cl*fc) constant. Indeed, it is enough for switching frequency fc of capacitances Cs to be adapted to the work frequency of amplifier 10 for the transconductance gains gm10 and gm40 to vary in the same direction.

Preferably, capacitor Cs is of same nature (same technology) as the capacitor(s) (Cl, FIG. 2) forming the loads of the biased amplifiers. This enables making the reference current generation compensated in capacitor manufacturing tolerances.

An advantage of the present invention is that the power consumption of the reference current generation circuit is self-adapting to the power required to bias the downstream assemblies.

Another advantage of the present invention is that the circuit remains compensated in temperature (the current is a function of ΔVgs′) and in transistor manufacturing tolerances.

Another advantage of the present invention is that it avoids the problem of resistor manufacturing tolerances.

Another advantage of the present invention is that, whatever the working frequency of the amplifier(s) (for example of an analog-to-digital converter), the generator adapts its power consumption to the surged current.

The obtaining of the working frequencies of the amplifiers to be biased is particularly easy in applications using a clock frequency. Such is especially the case for analog-to-digital converters for which it is enough to switch capacitance Cs of circuit 43 at the sampling frequency to obtain the desired effect.

In applications where different amplifiers work at different frequencies, it is possible to either individualize the reference current generation circuits, or to take into account the highest frequency. Even in this case, the power consumption is lower than with a conventional generator.

According to an alternative embodiment, capacitive element Cs (and/or element Ct) is formed of an active component, for example, a diode having its anode connected to terminal 3. An advantage is that, for a given capacitance value, the bulk is lower.

FIG. 5 shows a second embodiment of a reference current generation circuit 50 according to the present invention.

It also comprises a first branch of two P-channel and N-channel transistors MP51 and MN51 in series between terminals 2 and 3, and a second branch of two P-channel and N-channel transistors MP52 and MN52 in series with a switched-capacitance circuit 43, a capacitor Ct being in parallel with circuit 43. For simplification, control circuit 45 has not been illustrated in FIG. 5.

As compared with the assembly of FIG. 4, the gates of transistors MP51 and MP52 are connected to the drain of transistor MN51 and the gates of transistors MN51 and MN52 are connected to the junction point of two P-channel and N-channel transistors MP53 and MN53 in series between lines 2 and 3, forming a third branch. The gate of transistor MN53 is connected to the gates of transistors MN51 and MN52. The gate of transistor MP53 is connected to the interconnection between transistors MP52 and MN52. Preferably, an additional capacitive element C′ connects terminal 2 to the gate of transistor MP53 to stabilize the voltage of this gate.

In the embodiment of FIG. 5, assuming transistor MP52 to be of unity size, transistor MP51 has a greater size k1 and transistor MP53 has any size. Transistors MN51 and MN52 have identical sizes assumed to be unity sizes. Transistor MN53 has a size k3 greater than or equal to unity. Of course, what matters are the surface ratios between transistors of same type and the notion of unity size is arbitrary and different according to the channel type.

This embodiment enables avoiding a possible constraint on the sizes of capacitors Cs and Ct. Indeed, in the assembly of FIG. 4, the smaller capacitance Cs, the smaller maximum current Ir. The more current Ir must be amplified by the copying to generate the bias currents, the more this copying will generate a significant uncertainty. The greater capacitance Cs, the greater capacitance Ct must be and problems of integration of these capacitances may arise.

The embodiment of FIG. 5 enables making the difference between the gate-source voltages of transistors MN51 and MN52 a function of ratio k1 of the currents flowing in the first two branches. At the cost of a slight increase in the surface area taken up by the transistors, the size of capacitances Cs and Ct can then be reduced. The function of the third branch is to copy, to be used as a base for a subsequent copying for the bias currents, current k1*I of the first branch, which enables keeping a relatively low current I in the second branch, and thus in the capacitances. The current in the third branch is equal to k″I, with k″=k1*k3.

Of course, the present invention is likely to have various alterations, modifications, and improvements which will readily occur to those skilled in the art. In particular, the transposition of the described dual-assembly circuit by replacing the N-channel transistors with P-channel transistors and conversely is within the abilities of those skilled in the art based on the functional indications given hereabove.

Further, although the present invention has been described in relation with MOS transistors, it more generally applies to any transistor providing a transconductance gain proportional to the current in the branches. For example, the P-channel MOS transistors may be replaced with NPN-type bipolar transistors and/or the N-channel transistors may be replaced with PNP-type bipolar transistors in a bipolar or BiCMOS technology. The adaptation of the control circuit is within the abilities of those skilled in the art.

Moreover, the different circuit branches may be replaced with cascode assemblies of transistors to increase the output impedance, and thus the accuracy of the current copying.

Finally, the respective dimensions to be given to the different transistors according to the application and to the practical forming of an adapted control circuit are also within the abilities of those skilled in the art. For example, switches K1 and K2 will be transistors of same nature as the other transistors of the assembly.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A circuit for generating a reference current, comprising, between two terminals of application of a supply voltage:
at least a first branch of at least a first and of at least a second transistors in series, without a resistive element; and
at least a second branch of at least a third and of at least a fourth transistors, without a resistive element and in series with a switched-capacitance circuit comprising at least a first capacitive element.

2. The circuit of claim 1, comprising a second capacitive element across the switched-capacitance circuit.

3. The circuit of claim 2, wherein said second capacitive element has a capacitance greater, within a ratio of at least five, preferably of at least ten, than the capacitance of the first capacitive element forming the switched-capacitance circuit.

4. The circuit of claim 1, wherein said switched-capacitance circuit comprises said first capacitive element in parallel with a first switch, all in series with a second capacitor.

5. The circuit of claim 4, wherein said first capacitive element is formed in a same technology as a capacitive element of a load of an amplifier biased from a copying of the reference current.

6. The circuit of claim 1, comprising an element for controlling the switched-capacitance circuit at a frequency which is a function of the intensity of the required reference current.

7. The circuit of claim 6, wherein said frequency corresponds to the work frequency of at least one amplifier, a bias current of which is obtained by copying of the reference current.

8. The circuit of claim 1, wherein the control terminals of the first and third transistors are connected to the interconnection between the third and fourth transistors, the control terminals of the second and fourth transistors being connected to the interconnection between the first and second transistors.

9. The circuit of claim 1, wherein the control terminals of the first and third transistors are connected to the interconnection between the first and second transistors, the control terminals of the second and fourth transistors being connected to the interconnection of a fifth and of a sixth transistors in series forming a third branch between said supply terminals, the control terminal of the fifth transistor being connected to the interconnection between the third and fourth transistors and the sixth transistor being diode-assembled.

10. The circuit of claim 1, wherein the first and third transistors are MOS transistors of a first channel type, the second and fourth transistors being MOS transistors of a second channel type.

11. An amplifier comprising a bias current source, wherein the bias current is obtained by copying of a reference current generated by the circuit of claim 1.

12. An digital-to-digital converter, comprising at least one amplifier as claimed in claim 11.
